(19) United States
(12) Patent Application Publication
(10) Pub. No.: US 2004/0158752 A1
(43) Pub. Date: Aug. 12, 2004

(54) Power management system and method for electronic circuits

(76) Inventors: Michael Borza, Ottawa (CA); Neil Hamilton, Kanata (CA); Igor Gamayunov, Nepean (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/770,450

(22) Filed: Feb. 4, 2004

Related U.S. Application Data
(60) Provisional application No. 60/444,639, filed on Feb. 4, 2003.

(51) Int. Cl. G06F 1/32

(52) U.S. Cl. 713/320

(57) ABSTRACT

A hardware implementation of the Transfer Control Protocol/Internet Protocol (TCP/IP) software stack comprising multiple modular hardware gate level blocks used to implement the discrete functions required for link termination. These modules are designed using low power techniques to minimize the power required to achieve the data processing required by TCP/IP. These hardware blocks are modular so that they can be run at varying clock rates, or have various supply voltages provided thereto, depending on the throughput requirement of each block. Furthermore, at design time of each programmable hardware circuit (PHC) functional circuit blocks (FCBs) used to implement functionality within the PHC are optimized in accordance with predetermined parameters in order to obtain predetermined programmed PHC functionality, such as reduced power consumption or high bandwidth data throughput.

This application claims the benefit of Provisional Application No. 60/444,639 filed Feb. 4, 2003.

### FIELD OF THE INVENTION

The invention relates to the area of power management in electrical circuits and more specifically in the area of varying an amount of power provided to individual functional circuit blocks in dependence upon processing requirements of the functional circuit block.

### BACKGROUND OF THE INVENTION

Circuits used in electrical devices are typically designed from functional circuit blocks (FCBs), where each of these blocks is designed to carry out a specific process within the electrical device. The FCBs are electrically linked together to exchange data signals therebetween. By designing electrical circuits for electrical devices by using FCBs, advantages are realized in the area of electrical device power consumption. Power consumption plays an increasingly important role in modern devices that are being provided with increased functionality, but must maintain sufficient battery longevity in order for them to be sufficiently useful between battery recharge operations. For instance, cellular telephones have become widespread, but in order for their continued usefulness they must be able to operate for longer periods of time; an issue that becomes more difficult when an ever increasing number of features are integrated therein, such as, for example, color LCD video displays, or encryption processes.

It is well known to those of skill in the art to disable functional circuit blocks when they are not being utilized, such as U.S. Pat. No. 6,081,135, entitled “Device and method to reduce power consumption in integrated semiconductor devices.” This allows for electrical power stored in the battery to effectively not power a disabled FCB while that FCB is not being utilized, thus advantageously saving battery power until the previously disable FCB is required. Previously, in order to conserve power, the entire circuit was provided with a reduced power, which extended the battery life of these devices, but offered significantly reduced performance. Of course, other options are to also disable portion so these FCBs, leading to the same advantage that these shut down portions consume less power since they are disabled. Of course, the circuits used to monitor whether these circuits are required consume power, however these monitor circuit still use less electrical power than the disabled FCBs.

Unfortunately, as the functional circuit blocks are enabled after being disabled, buffering of data therebetween must take place in order for the functional circuit blocks to reinstate its operation before it can accept the data. Buffering of data is known to consume power because logic gates in the memory circuit must be powered up, thus using electrical power. In addition electrical power is consumed in order to maintain predetermined logic states in a memory circuit. A need therefore exists to provide a circuit in an electrical device made from functional circuit blocks that reduces a need for buffering of data between the FCBs as they are being enabled.

If is therefore an object of the invention to provide an electrical device that is made up of individual functional blocks that are individually controllable in terms of their power consumption, especially when these functional blocks are used in portable computing devices. Furthermore, it would be beneficial to reduce the amount of power associated with tasks involving network, transport and session layer protocols for computing devices.

### SUMMARY OF THE INVENTION

In accordance with the invention there is provided a computing device comprising: a plurality of functional circuit blocks (FCB)s; and, a power controller for reducing power consumption provided to at least a FCB, the at least a FCB fewer than all of the plurality of FCBs, and of at least one of the FCBs in isolation, the power controller for other than disabling the functionality of the FCB having reduced power provided thereto.

In accordance with the invention there is provided a storage medium having stored thereon data for defining an integrated circuit component, the data including: data for a plurality of functional circuit blocks (FCB)s; and, data for a power controller for reducing power consumption to at least a FCB, the at least a FCB fewer than all of the plurality of FCBs, and of at least one of the FCBs in isolation, the power controller for other than disabling the functionality of the FCB having reduced power provided thereto.

In accordance with the invention there is provided a method of programming a programmable hardware circuit (PHC) to provide a programmed PHC, the programmed PHC for providing circuit functionality using functional circuit blocks (FCB)s comprising: providing first performance parameters; determining a first group of FCB macros that are to be used for implementing of a first set of functions within the PHC; optimizing the first group of FCB macros in accordance with the first performance parameters; and, programming the first group of optimized macros into the PHC in order to form a programmed PHC that operates using the first performance parameters.

In accordance with the invention there is provided a method of programming a programmable hardware circuit (PHC) to provide a programmed PHC, the programmed PHC for providing circuit functionality using functional circuit blocks (FCB)s comprising: providing first performance parameters; providing second performance parameters; determining a first group of FCB macros that are to be used for implementing of a first set of functions within the PHC; determining a second group of FCB macros that are to be used for implementing of a second set of functions within the PHC; optimizing the first group of FCB macros in accordance with the first performance parameters; optimizing the second group of FCB macros in accordance with the second performance parameters; programming the first group and the second group of optimized macros into the PHC in order to form a programmed PHC that operates using one of the first performance parameter and the second performance parameters; and, providing an input port for receiving a mode of operation signal to select whether the programmed PHC is to operate using one of the first performance parameter and the second performance parameters.

### BRIEF DESCRIPTION OF THE DRAWINGS

The invention will now be described with reference to the figures in which:

FIG. 1 illustrates power control of two functional circuit blocks using a different variable supply voltage provided to each of the blocks using a power control circuit;

FIG. 2 illustrates power control of two functional circuit blocks using a different variable clock frequency provided to each of the blocks using a power control circuit;

FIG. 3 illustrates power control of two functional circuit blocks using a different variable supply voltage as well as a different variable clock frequency provided to each of the blocks using a power control circuit;

FIG. 4 illustrates power control of two functional circuit blocks in dependence upon processing requirements for each functional circuit in dependence upon data provided to and retrieved from a buffer memory;

FIG. 5 illustrates power control of two functional circuit blocks, in combination with a buffer memory for providing data to the functional circuit blocks, with a bus between the functional circuit blocks used to bypass storing of data back into the buffer memory after processing thereof in order to further reduce power;

FIG. 6 illustrates a lookup table stored within the power control circuit for determining how much power to provide to each of the functional circuit blocks;

FIG. 7 illustrates a prior art apparatus for TCP/IP termination and security to process all of the data for OSI protocol layers 3 to 7 using a host processor;

FIG. 8 illustrates a high-level block diagram of a system according to the invention for implementing TCP/IP termination over a physical link;

FIG. 9 illustrates a high-level block diagram of a system according to the invention;

FIG. 10 illustrates a block diagram of an alternative embodiment of the invention that supports encryption functions;

FIGS. 11a and 11b illustrates another embodiment of the invention, a programmable circuit that has functional circuit blocks programmed therein in dependence upon predetermined performance characteristics of the circuit block; and,

FIGS. 12a and 12b illustrates another embodiment of the invention, programming of two different types of functional circuit blocks into a programmable circuit, the programmable circuit having either one of the two types of circuit blocks enabled in dependence upon an input signal.

### DETAILED DESCRIPTION

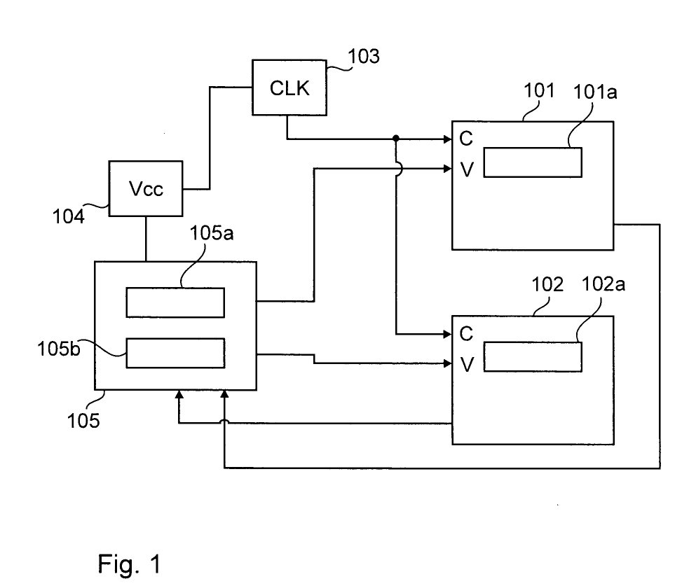

Referring to FIG. 1, a first embodiment of the invention is shown. A clock signal source 103 is used for providing a clock signal to a first FCB 101 and to a second FCB 102. A voltage source (Vcc) 104 is coupled to a power control circuit (PCC) 105. A first output port from the PCC 105 voltage control section 105a is coupled to a voltage input port on the first FCB 101 and a second output port from the PCC 105 voltage control section 105a is coupled a voltage input port on the second FCB 102. The PCC 105 in turn receives first and second data processing signals from each of the FCBs (101 and 102), respectively, in order to use this information for varying of the Vcc supplied to each of the FCBs. Thus, in dependence upon the requirement for processing capacity of each FCB, the voltage provided thereto is varied. The more the supply voltage is reduced to each FCB, the lower the power consumption of that FCB. Of course, at a certain threshold the FCB no longer operates and thus only leakage current is observed therein. Thus, instead of maintaining power to an FCB that is not performing any tasks, the PCC disables the voltage supplied, and/or varies the clock frequency provided to that FCB in order to conserve power. Of course, the power supplied to each FCB is scaleable in dependence upon the power requirements of the FCB. Therefore, the first FCB may for instance receive 40% of its normal power and the second FCB may receive 60%. Of course, the circuit shown in FIG. 1 resides on a common substrate and power to each of the FCBs is individually controllable to reduce the power consumption of each of these FCBs in dependence upon their processing requirements as noted by their data processing signals.

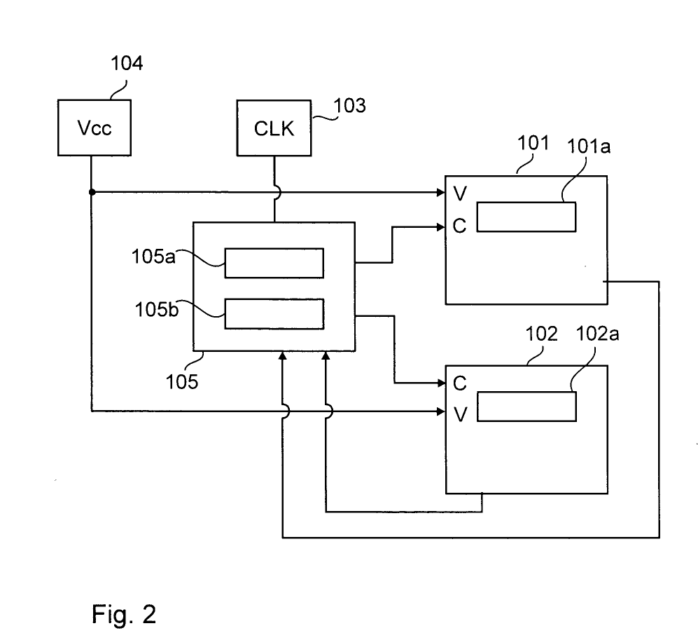

Referring to FIG. 2, a second embodiment of the invention is shown. In this case, a voltage source 105 (Vcc) is used for providing a supply voltage to a first FCB 101 and to a second FCB 102. A clock signal source 103 is coupled to a power control circuit (PCC) 105. A first output port from the PCC 105 clock varying section 105b is coupled to a clock input port on the first FCB 101 and a second output port from the PCC 105 clock varying section 105b is coupled a clock input port on the second FCB 102. The PCC 105 in turn receives first and second data processing signals from each of the FCBs (101 and 102), respectively, in order to use this information for varying of the clock frequency supplied to each of the FCBs. Thus, in dependence upon the requirement for processing capacity of each FCB, the clock signal frequency provided thereto is varied. It is known to those of skill in the art that faster clock rates lead to faster processing times, and slower clock rates lead to slower processing times. Of course, the faster the clock rate that is provided to that FCB, the more power the FCB will consume. At a certain point the clock rate is sufficiently slow that the FCB is effectively disabled, thus saving power. This would be the case for an FCB that is not being utilized for processing intensive tasks. Of course, the clock rate supplied to each of the FCBs is dependent upon their processing requirements and is varied in dependence upon the first and second data processing signals. So, for example, the clock rate provided to the first FCB may be 10% of the clock rate supplied by the clock signal source 103, and the clock rate supplied to the second FCB may be 90% of the clock rate of the clock signal source 103.

Of course, a memory, 101a and 102a, is provided within each of the FCBs. Thus, when the FCBs are operating at reduced power, each of them operate in essentially their own environment, which means that when data is exchanged therebetween, the reduced clock cycles used for processing of the data preferably does not affect the data transfer speeds. Preferably, once the FCB b has processed its data, its clock rate is then synchronized with that of another FCB to facilitate transferring of data therebetween.

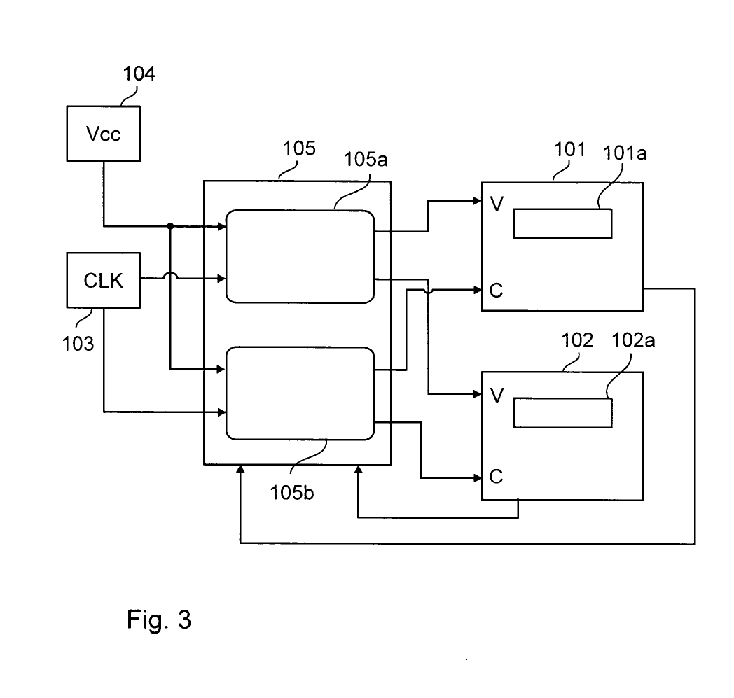

Referring to FIG. 3, a third embodiment of the invention is shown. In this case, a voltage source 105 (Vcc) and a clock signal source 103 are both coupled to a power control circuit (PCC) 105. A first output port from the PCC 105 clock varying section 105b is coupled to a clock input port on the first FCB 101 and a second output port from the PCC 105 clock varying section 105b is coupled a clock input port on the second FCB 102. A first output port from the PCC 105 voltage control section 105a is coupled to a voltage input port on the first FCB 101 and a second output port from the PCC 105 voltage control section 105a is coupled a voltage input port on the second FCB 102. The PCC 105 in turn receives first and second data processing signals from each of the FCBs (101 and 102), respectively, in order to use this information for varying of both the clock frequency and the supply voltage provided to each of the FCBs.

From the previous two embodiments, it is known that by varying both the clock signal frequency supplied to each FCB and by varying the supply voltage supplied to each FCB, the power consumption of the FCBs can be drastically reduced. Up to a point where the FCB does not even experience leakage current because the Vcc supplied to the given FCB is essentially at ground potential. Of course, an amount of voltage and the clock signal frequency are dependent upon the received first and second data processing signals.

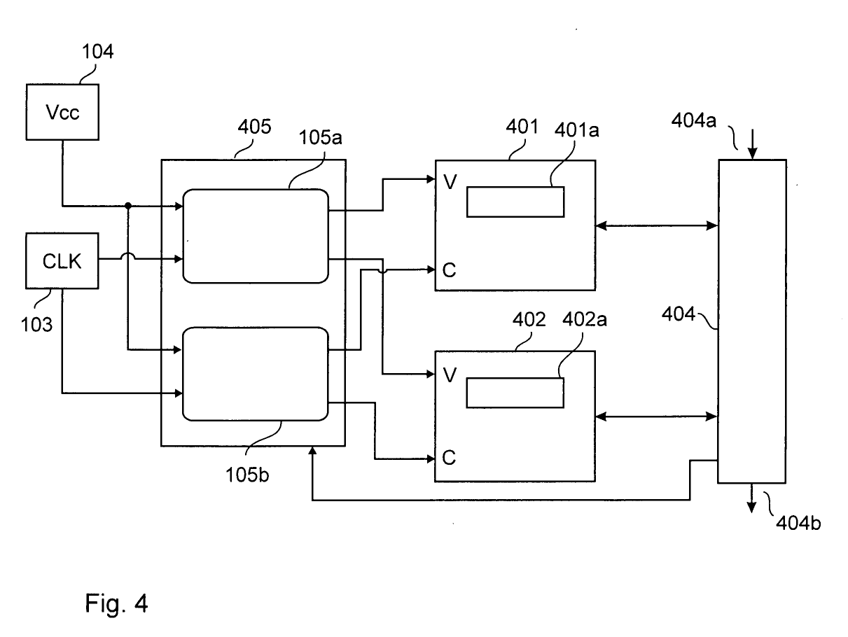

Referring to FIG. 4, the third embodiment is shown in addition to a buffer memory 404. The buffer memory 404 facilitates transferring of data between the FCBs. An input port 404a is provided on the buffer memory for receiving of data and an output port is provided on the buffer memory 404b for outputting data from the buffer memory 404. Thus, for example the system shown in FIG. 4 is used for receiving of a TCP/IP signal. The first FCB 401 is used for processing TCP/IP signals and the second FCB 402 is used for encryption processing.

The PCC 405 monitors the status of data in the buffer memory 404 and in dependence upon a data processing signal indicative of an amount of processed data output from the buffer memory output port, the PCC varies the VCC and clock frequency that is applied to each of the FCBs. If for example the data processing signal indicates that the TCP/IP signal being received is a pure TCP/IP signal, and it is not encrypted, then the TCP/IP FCB 401 is provided with a non reduced VCC and a non reduced clock rate by the PCC 405. The encryption FCB 102 on the other hand is provided with at least one of a reduced VCC and a reduced clock rate. Optionally, the VCC is reduced to such a point that the encryption processor is effectively provided with zero potential, thus effectively disabling its circuit functionality. By disabling the encryption processor, battery power for the device is conserved since this power is not wasted on powering of the encryption FCB 402. Thus, the TCP/IP FCB 401 is provided with approximately 100% of its normal operating power and the encryption FCB 402 is effectively provided with 0%.

In the case of an encrypted TCP/IP signal being received on the memory buffer input port, the encryption FCB is enabled in order to encrypt/decrypt data being received. Of course, depending upon the type of encryption utilized for encoding or decoding, power requirements of the encryption FCB 402 will vary. Encryption processing is known to be processing intensive and thus providing a significant amount of power to the encryption FCB 402 is necessary. Thus, for example, for an intensive encryption throughput the clock rate provided to the encryption FCB is almost at a maximum clock rate, as well as the VCC provided to the encryption FCB is also at an approximate maximum. In this case for example, the encryption FCB 401 is provided with 90% power and the TCP/IP FCB 402 is provided with 10% power. If for instance 1 in 10 packets received by the TCP/IP are encrypted then perhaps both of the FCBs receive 50% power each. Of course, the power provided to each is dependent upon the usage requirements of each FCB. The usage requirements depending upon throughput demands placed on each of the FCBs as indicated by the data processing signal received from the buffer memory.

Advantageously, the power consumption of each FCB is controlled in such a manner so as to enable each FCB to operate with enough throughput that it does not cause a bottleneck to the system, yet while maintaining a power consumption that is less than that what the FCB would be using if it were not moderated.

In another example, in the case of multiband cellular telephones, there are typically three standards that are used in the industry. These phones termed “tri mode” contain necessary FCBs within that allow the phone to operate, for the most part, all over the world, in accordance with communication standards located in proximity of the phone. Typically, within these phones there are FCBs that are adapted for use with each of these standards. Unfortunately, if the power is not regulated to each of these standard specific FCBs, these types of phones will consumer a lot more power then their “single mode” counterparts. Thus, for example, if encryption is required by a given protocol, then an encryption FCB residing in each of the standard specific FCBs is utilized for the performing thereof. However, because each of the standard specific FCBs may contain an encryption FCB, only a single encryption FCB is necessary to carry out the communicating encryption and decryption processes. Furthermore, each of the standards also requires a different bandwidth to carry out its operations. Thus, in order to optimize the power usage of such a tri mode phone, powering up and down of standard specific FCBs is not advantageous. What would be more advantageous is to provide multiple FCBs within the telephone that are shared by each of the communication standards. For example, a single encryption FCB is provided within the device for encryption processing for each of the standards. Not only does this save circuit layout area, but also saves power because only having one encryption FCB and not multiples reduce leakage current in the circuit. Thus, when one communication standard requires more power for encryption processing, then for example, the encryption FCB is provided with 70% power. In another example when the encryption processing is not very intensive, then the encryption FCB is only provided with 30% power. Depending upon the bandwidth requirements of the communication standard being utilized by the phone a the time, the power provided to the FCBs in the phone is managed in order to ensure that sufficient bandwidth is realized by the telephone, while maintaining optimum power consumption. In this case again, the VCC and the clock rate are varied to the encryption FCB to ensure that the sufficient bandwidth is realized and power consumption is minimized. Of course, these power levels are dependent upon the data processing signal provided to the PCC.

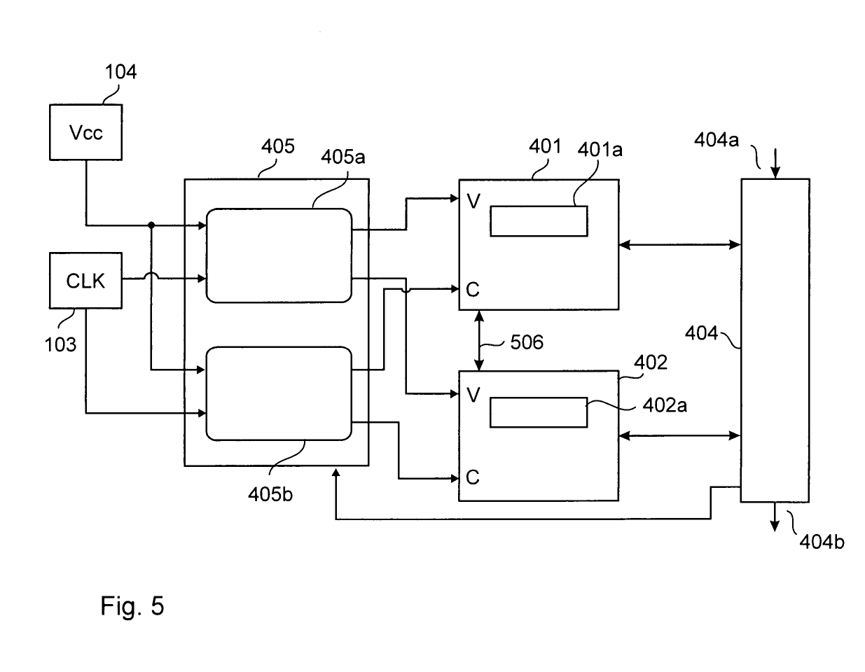

Referring to FIG. 5, a fourth embodiment is shown in combination with the buffer memory 404. The buffer memory 404 in this case is for receiving data from an input port 404a located therein. A data bus 506 is provided between FCBs 401 and 402. The data bus 506 is used to transfer of data between these FCBs without the FCBs using the buffer memory to exchange data therebetween. Of course, the buffer memory 404 is used to provide data to the FCBs, but after processing of the data by the FCB, the FCB forwards the data to the second FCB 402, such that intermediate storage of the data within the memory buffer 404 is preferably obviated.

Advantageously, by controlling the processing capabilities of each FCB by varying the power provided, a further power consumption advantage is realized with the device. When data is processed within the device by an FCB, once the FCB is done processing a portion of the data, the data is provided to another FCB. For example, if a cellular telephone is equipped with an LCD screen capable of displaying graphics, then three basic FCBs would be a receiver FCB, a image decoding FCB and a display FCB. If the receiver FCB is receiving the data at a rate that is too high for the image decoding FCB, then the data is typically buffered therebetween. Additionally, if the display FCB is slow in displaying the data on the LCD screen, then the data is buffered between the image decoding FCB and the display FCB. To those of skill in the art, it is known that buffering of data involves storing of the data in a memory circuit. Memory circuits are provided with input and output ports, which are controlled by number of logic gates. The memory storage locations also are made up of logic gates in the case of SRAM memories, or refresh circuits when DRAM memories are employed. Thus, buffering of data in memory circuits is a power consumption intensive process because logic gates are operated, which proves to be disadvantageous when power requirements for a device are to be minimized. By advantageously controlling the power provided to each FCB, resulting in varying the processing capabilities of each FCB, buffering of data is preferably reduced. In dependence upon a desired output bandwidth, power is varied to the FCB components leading up to a final FCB that provides a desired output bandwidth, such that power consumption is further reduced by not having to buffer data between FCBs.

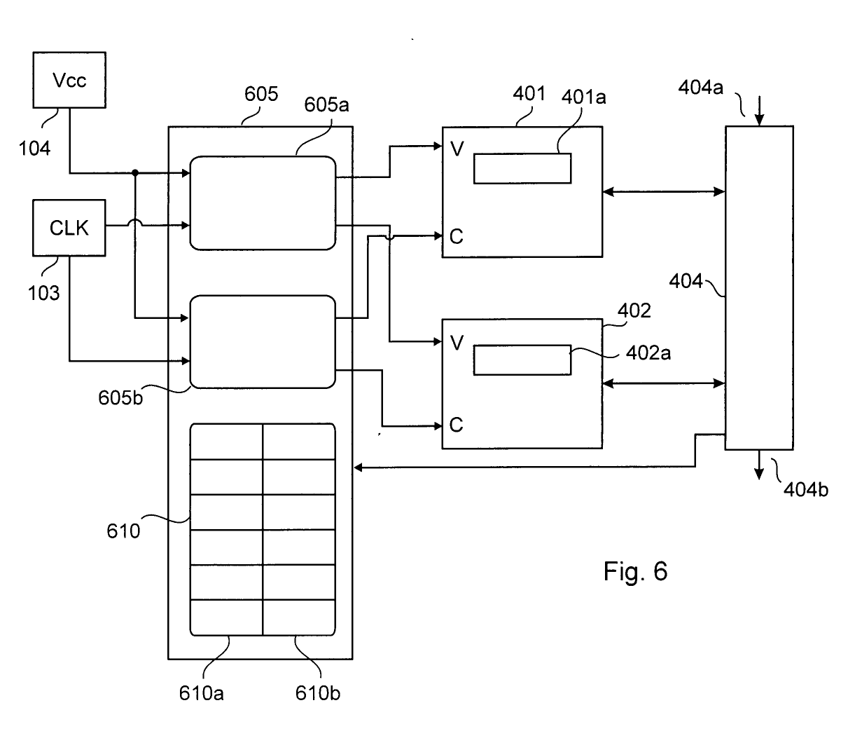

Referring to FIG. 6, a fifth embodiment of the invention is shown. In this case the PCC 605 is provided with a lookup table 610 therein. The lookup table 610 contains at least a first column 610a that has entries pertaining to the data processing signal received from the buffer memory 404 and at least a second column 610b that contains entries that are used for determining power consumption values that are provided to each of the FCBs (401 and 402). Thus, in dependence upon the data processing signal, different power consumption values are provided to the FCBs in order to control the power consumption as well as to maintain required FCB functionality for processing of data received from the buffer memory as well as other FCBs.

In a computer attached to a wireless network system a set of protocol layers are defined by the Open Systems Interconnect consortium, as is well known to those of skill in the art. Layers 1 and 2, the Physical Layer and Datalink Layer Protocol respectively, are usually closely related to the method of data transmission and would be unique for different protocols such as 802.11, Bluetooth, CDMA or others. These are often implemented in hardware. The next 3 layers of the protocol called the network (Layer 3), transport (Layer 4), and session (Layer 5) protocols are implemented as software in portable devices. This allows a general-purpose device such as a portable computer to be used in many different network setups and support any arbitrary network application that is needed. The result of this implementation, however, is that the system uses a significant portion of the processing power of the processor as well as a large amount of system memory. Additionally, configuring the different software protocol and data handlers communicating to the host computer processor often involves a set of complex tasks for the user of the system.

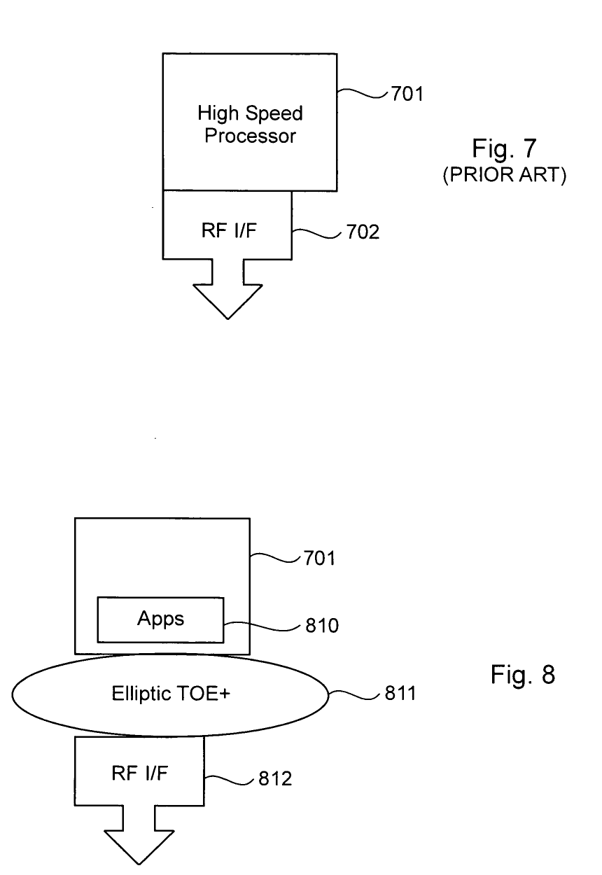

Referring to FIG. 7, a prior art apparatus for TCP/IP termination and security is to process all of the data for OSI protocol layers 3 to 7 using a host processor 701, is shown. Packet data is transported to and from the medium through layers 1 and 2, often implemented in hardware 702. With the advent of much higher speed networks this creates a processing load that is beyond the capabilities of most processors for portable applications and, even if the packet data were processed within the time limits desired, would result in increased power and thermal load of the host processor 701. In battery-powered mobile computing applications, it is very beneficial to reduce the energy consumed by the host processor 701 because this will permit more use of the mobile computing device between recharging or changing of a portable battery.

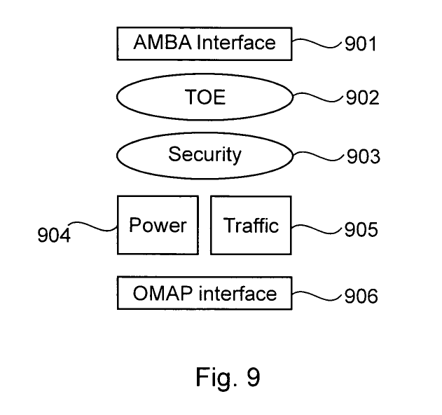

Referring to FIG. 8, an embodiment according to the invention is shown having host processor 701 executing applications 810, a TCP/IP offload engine (TOE) 811, and a hardware interface 812. This embodiment of the invention converts the processing of Layers 3, 4, and 5 into a hardware gate level implementation, which substantially reduces the processor 701 load and power dissipation, permitting the use of a slower smaller host processor to process only Layers 6 and 7 of the protocol. Layers 6 and 7 vary from application to application while Layers 3, 4, and 5 are common to all TCP/IP based data protocols, implemented on top of a network, such as 802.11, W-CDMA, Bluetoothe and others. For this reason Layers 6 and 7 are best implemented in software but the commonality of TCP/IP termination and Security processing render them amenable to conversion to hardware. The implementation of the zero copy protocol stack in hardware gate level allows for real time decoding of packet data as it is received, reducing the need for storage buffers.

Optionally, these functions are implemented in field programmable gate arrays (FPGAs), programmable array logic (PALs), or read only memory (ROMs). Additionally, specific protocols and data types have been indicated but the modularity of this embodiment of the invention does not limit it to those specific protocols or data types.

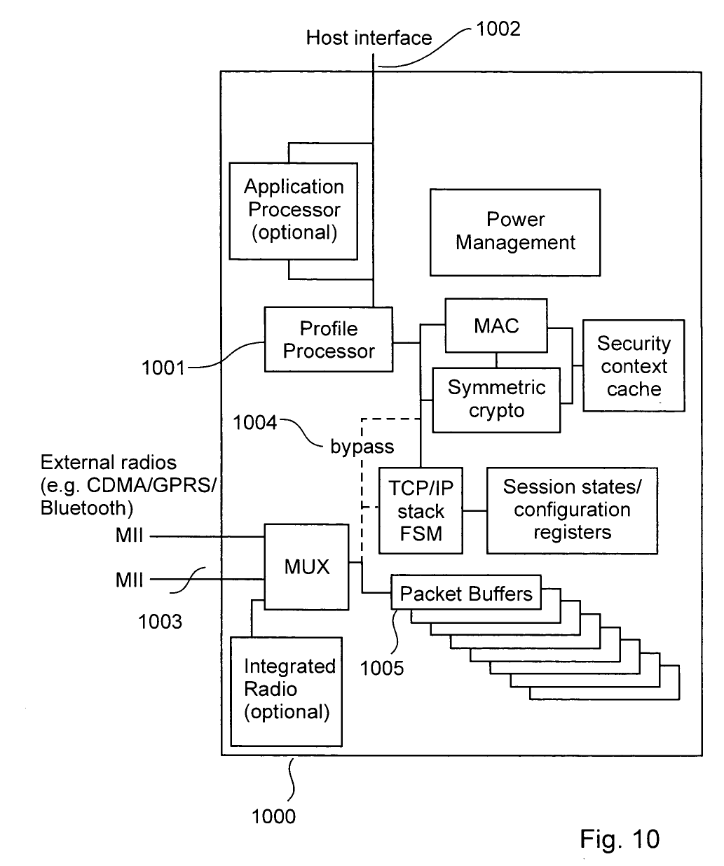

Referring to FIG. 9, an embodiment of the invention is represented with a high-level block diagram. This diagram describes one possible implementation of the invention in simple form. The interfaces to the higher levels of the protocol are many and varied—they may include the AMBA interface 901 promoted by ARM or other interfaces for other types of processors or system Input/Output busses.

The TCP/IP Offload Engine (TOE) 902 is comprised of one or more finite state machines, processors and hardware required to implement the appropriate functions for termination of the data stream including packet buffering, parsing and interpretation of the data headers, error checking and correction, collision avoidance and retransmission protocols and other functions as required by the specification. The TOE 902 interacts with the other blocks in the invention to minimize power and memory requirements by using a grab-and-go, drop-and-go philosophy to queue processing jobs onto appropriate resources with minimal handshaking.

The Security Offload Engine 903 is comprised of one or more finite state machines, processors and additional hardware used to implement the appropriate functions for security processing under protocols such as IPv4, IPv6, IPSec, WEP, WPA, 802.11i or others. The Security resources interact with the other blocks in the device according to the invention to minimize power and memory requirements by using a grab-and-go, drop-and-go philosophy to queue processing jobs onto appropriate resources with minimal handshaking.

The Power management block 904 manages the gating and synchronization of system clocks to the various blocks in the invention such that portions of the device which are not necessary are not consuming power by switching unnecessarily when they should be in the off state. It also may control the voltage levels used to power the invention, the slew rates of clocks and drivers within the functional logic, the voltage bias applied to minority carrier wells when functions are in the ‘OFF’ state to minimize leakage, and other functions meant to minimize power consumption.

The traffic management block 905 interfaces with all of the hardware resources in the invention to balance the loads to minimize power and memory requirements by using a grab-and-go, drop-and-go philosophy to queue processing jobs onto appropriate resources with minimal handshaking. This is especially important when multiple data streams are being terminated simultaneously as in a ‘web-browsing’ HTTP application.

The layer 2 datalink layer interface 906 is implemented as an OMAP interface, or another standard implementation. In other embodiments of the invention feature other interfaces for other types of signal processors and system input/output busses.

The TOE 902, Security Offload Engine 903, Power Management Block 904, and Traffic Management Block 905 can recognize non-standard packets, packet fragments or other situations not defined by the protocol and can pass packet data in a useful fashion to the Host processor. The Host processor software then determines if the packet data represents an error condition, which is not defined by the TCP/IP, or other protocol, or a new packet type not recognized by the invention. In the case of a change to the protocol specification, obsoleting some portion of the invention hardware, the Host processor software can be updated to seamlessly correct such conditions when they occur resulting in extra Host processor load but in a continued power savings in most normal data transmission situations. Additionally, state machine confirmation data and protocol sequencing can be downloaded to the security engine and/or the TOE.

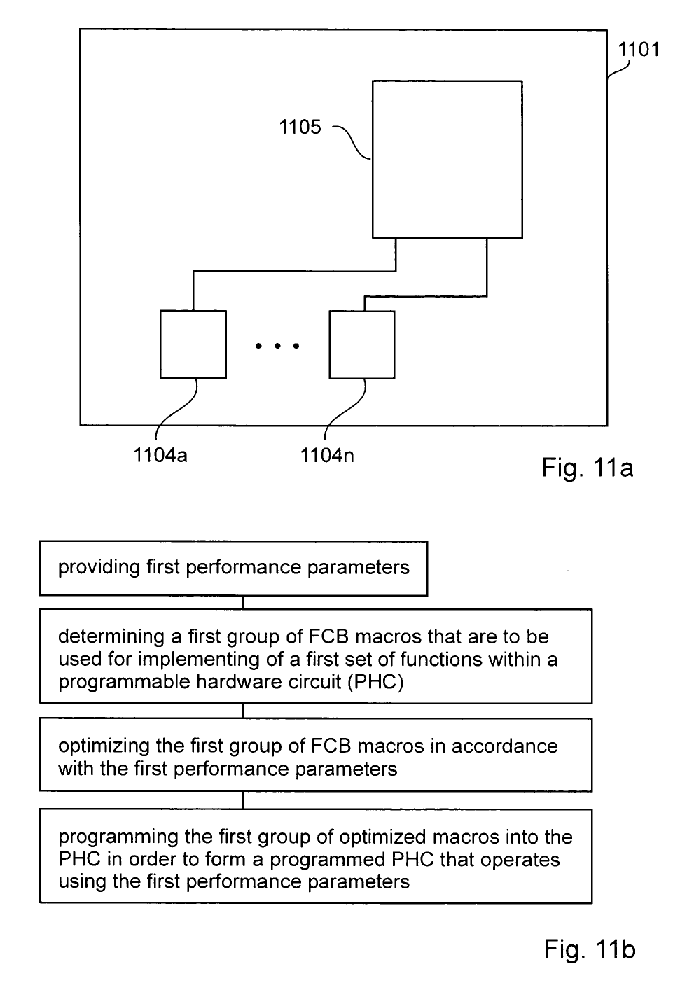

Referring to FIG. 10, a block diagram of a system 1000 according an embodiment of the invention is shown. The system communicates with applications through a host interface port 1002. The system communicates with external systems via a wireless connection 1003. A variety of hardware circuits are disposed within the block diagram of the system 1000 for facilitating the communications between the wireless connection 1003 and the host interface 1002.

In this system 1000, a dedicated hardware circuit 1001 is used to convert data between different formats. The system 1000 includes a first set of dedicated circuits for accelerating encryption algorithms. Thus, the host processor (not shown) is not burdened with common encryption tasks thereby permitting the host processor to complete other tasks. Additionally, this system includes a second set of dedicated circuits for handling data having different protocols. These circuits are able to change the format of data to ensure that it is provided in a manner consistent with common protocols. Since this second set of dedicated circuits performs only one set of functions, they are able process data while using very little electrical energy in comparison to the amount of energy expended by a host processor performing the same data formatting changes. Providing a bypass bus 1004 advantageously allows for received wireless data from the wireless connection 1003 to be provided directly to some of the FCBs prior to being stored in a packet buffer 1005.

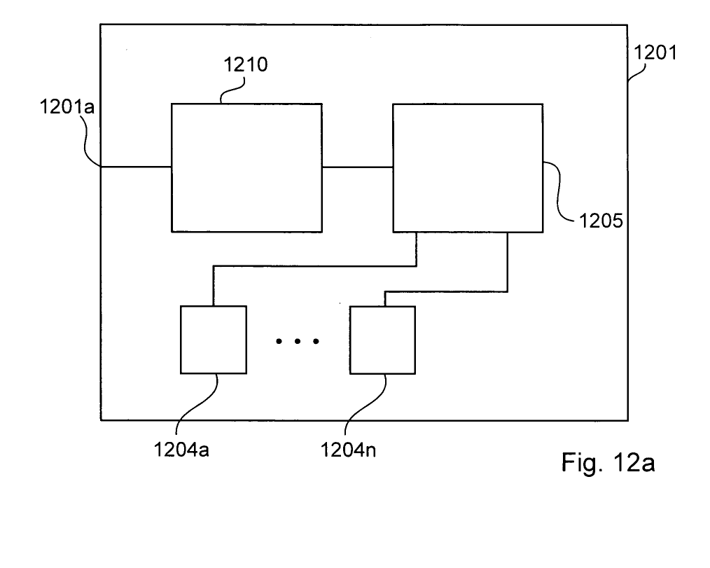

In another embodiment, as illustrated in FIG. 111a, with a method of programming thereof outlined in FIG. 11b, hardware description language source code, in VHDL or Verilog for example, is used in creating of the FCBs in a programmable hardware circuit (PHC). For example, within a programming system, macros that are used to create each FCBs are defined therein. These macros, when implemented within the PHC 1101, are used to define the individual FCBs 1104a through 1104n within the PHC 1101 once it is programmed. Thus, once the PHC 1101 has been programmed using the desired macros, the PHC 1101 operates in accordance with the FCBs as instructed by that macro. Of course, when designing of the PHC 1101, various operating parameters are preferably supported in order to realize desired performance parameters forming a profile for the PHC 1101 once it is programmed. For example, prior to programming of the PHC 1101, the macros are optimized within the programming system in such a manner that the resulting PHC 1101, once programmed, operates in accordance to these desired performance parameters. For example, one desired performance profile parameter is power consumption and another is processing bandwidth. Of course, typically there is a tradeoff between the two, where the desired performance profile for the programmed PHC 1101 is selected such that a desired power to performance ratio is achieved.

If the desired performance parameters, used for optimizing of the PHC 1101 prior to programming, is minimal power consumption, then once the programmed PHC 1101 when used in an electrical circuit, it will preferably draw minimal power thereafter. Of course, since the programmed PHC 1101 is designed to operate using minimal power consumption, it does not necessarily mean that the programmed PHC 1101 operates using maximum speed.

Typically, the macros for use in creating the FCBs within the PHC 1101 are stored on a storage medium. The storage medium is thus read by the programming system and the data for the FCBs and power controller circuit 1105 is programmed into the PHC 1101 to form a programmed PHC 1101. The power controller circuit 1105 is for controlling the power provided to each of the FCBs 1104a through 1104n.

In another example, when the programmed PHC 1101 is for use in a high bandwidth application then speed is of prime importance. Thus, the performance parameters provided are reflective of optimizing the PHC 1101 for maximum processing speed. The programming system PHC 1101 macros are chosen in accordance with the performance parameters and optimized in such a manner that approximately a maximum throughput is achievable once the PHC 1101 is programmed with those macros. Of course, by selecting maximum bandwidth as a desired performance parameter, that does not necessarily imply that other desired performance parameters are met, such as power consumption. Typically, a tradeoff is realized.

In accordance with this embodiment, the optimization of FCBs that are utilized within the programmed PHC are such that the programmed PHC 1101 operates in accordance with the desired performance parameters. Of course, once the PHC 101 is programmed, the FCBs that are used to implement functionality are not alterable by software. Thus, the FCB is limited to operate with the predetermined profile selected at the time of programming. This means that the portability of this programmed PHC 1101 is limited to operate in only an environment for which it was designed. However, by optimizing it for different environments via the desired performance parameters, its applicability to various scenarios is advantageously increased.

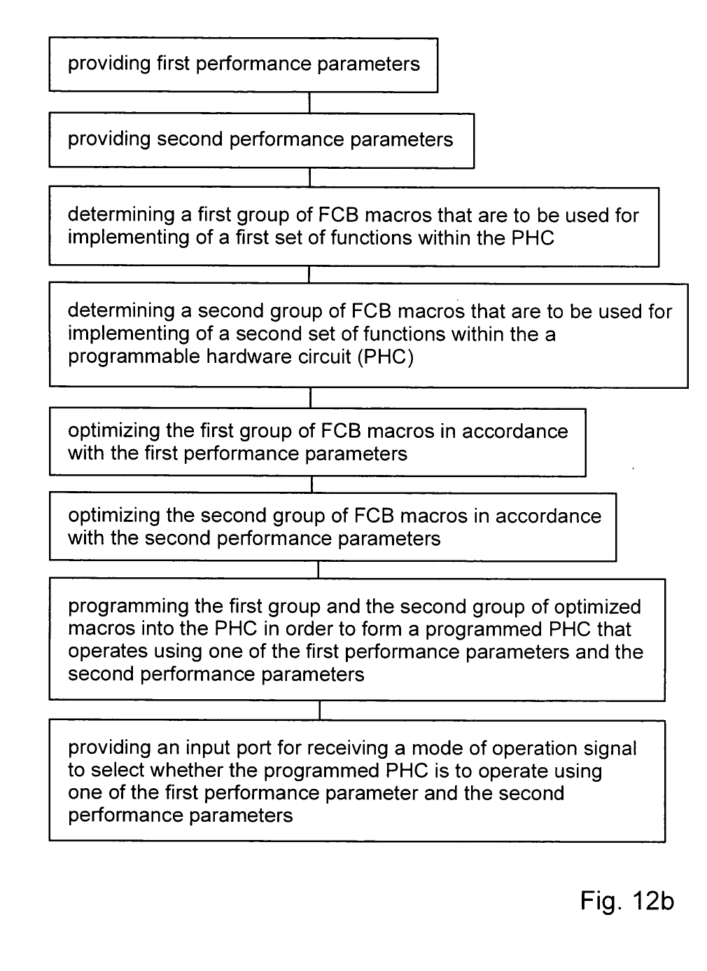

In another embodiment of the invention, as illustrated in FIG. 12a, with a method of programming thereof outlined in FIG. 12b, a PHC 1201 is provided that allows the PHC 1201 to operate according to more than one predetermined set of performance parameters forming a profile. In this embodiment the programmed PHC 1201 is provided with an input port 1201a that allows an end user to select which set of desired performance parameters are to be implemented at a predetermined time. A profile processor 1210 implemented in the PHC 1201 is used to determine which profile, or predetermined set of performance parameters, the programmed PHC 1201 is to use to operate. Preferably, the desired performance parameters are switchably selectable therebetween. In order to facilitate such a programmed PHC 1201, at least two groups of FCB macros are implemented in the programming system, where each set of macros is optimized with a specific set of desired performance parameters. Once these optimized macros are programmed into the PHC 1201, the PHC 1201 operates using either the first group or the second group in dependence upon an input signal provided to the input port 1201a of the PHC 1201 that is coupled to the profile processor 1210. In this manner, the portability of this type of programmed PHC 1201 in accordance with this embodiment increases. Now, a user switchably selects whether to enable the first or the second group of FCBs such that for example, in a first mode of operation, when the programmed PHC 1201 is operating in an other than power conserving mode of operation, the programmed PHC 1201 operates using high bandwidth throughput and thus consumes normal amounts of electrical power. In the second mode, when for example the programmed PHC 1201 operates using battery power, reducing power consumption is preferable, and hence the second group of FCBs facilitates reduced power consumption operation at an expense of increased throughput bandwidth. Optionally, a PROM is coupled to the programmed FCB, with an output port from the PROM coupled to the input port of the profile processor 1210 in order to provide the programmed FCB 1201 with an input signal for switchably selecting between the different modes of operation.

In this embodiment the storage medium has data stored therein for profile processing. Once the profile processor is programmed in to the PHC, the profile processor reads the input signal and performs selection of different operating profiles for the programmed PHC.

Although the invention is described herein with reference to the specific embodiments presented herein, one skilled in the art will readily appreciate that a wide variety of embodiments of the invention may be envisioned by a person of skill in the art of wireless network architectures without departing from the spirit and scope of the present invention.

What is claimed is:

1. A computing device comprising:
a plurality of functional circuit blocks (FCB)s; and,
a power controller for reducing power consumption provided to at least a FCB, the at least a FCB fewer than all of the plurality of FCBs, and of at least one of the FCBs in isolation, the power controller for other than disabling the functionality of the FCB having reduced power provided thereto.

2. A computing device according to claim 1, wherein the power controller comprises a clock rate controller circuit for varying the clock rate of the clock signal provided to a FCB.

3. A computing device according to claim 2, wherein the power controller comprises a voltage varying circuit for varying a supply voltage provided to a FCB.

4. A computing device according to claim 1, wherein the power controller comprises a voltage varying circuit for varying a supply voltage provided to a FCB.

5. A computing device according to claim 1, wherein the power controller comprises control circuitry for controlling power consumption of each of the plurality of FCBs, independently.

6. A computing device according to claim 5, wherein the power controller includes a clock rate controller for independently varying a clock rate of a clock signal provided to each of at least two of the at least an FCB.

7. A computing device according to claim 5, wherein the power controller includes a voltage controller for independently varying a supply voltage of a voltage source provided to each of at least two of the at least an FCB.

8. A computing device according to claim 1, comprising a profile processor for receiving policy data and for providing profile data to the power controller for use in determining at least one of a plurality of available power controllers for one of enabling and disabling and configuring thereof.

9. A computing device according to claim 8, comprising a lookup table, the lookup table for storing the profile data provided to the power controller.

10. A computing device according to claim 9, wherein the lookup table comprises data for performance parameters related to power consumption of the at least an FCB.

11. A computing device according to claim 8, comprising a programmable read only memory (PROM) for storing of the lookup table.

12. A computing device according to claim 1, wherein the computing device is formed in an integrated circuit.

13. A storage medium having stored thereon data for defining an integrated circuit component, the data including:
data for a plurality of functional circuit blocks (FCB)s; and,
data for a power controller for reducing power consumption to at least a FCB, the at least a FCB fewer than all of the plurality of FCBs, and of at least one of the FCBs in isolation, the power controller for other than disabling the functionality of the FCB having reduced power provided thereto.

14. A storage medium according to claim 13, wherein the data includes profile processing data for use in profile processing, the profile processing data for use in programming of the integrated circuit component for changing the configuration thereof.

15. A storage medium according to claim 14, wherein the profile processing data comprises data for use in determining performance parameters related to power consumption.

16. A storage medium according to claim 14, wherein the profile processing data includes profile processing data for use in implementation of the integrated circuit component design in accordance with the profile processing data and variable user profile data provided to a design tool for use therewith.

17. A storage medium according to claim 16, wherein the user profile data comprise data relating to a power: performance ratio for the integrated circuit device.

18. A storage medium according to claim 14, wherein the profile processing data comprises data for balancing performance of the profile processor between different functions thereof.

19. A storage medium according to claim 14, wherein the profile processing data comprises data for balancing performance of the profile processor between different profiles supported thereby.

20. A method of programming a programmable hardware circuit (PHC) to provide a programmed PHC, the programmed PHC for providing circuit functionality using functional circuit blocks (FCB)s comprising:
providing first performance parameters;
determining a first group of FCB macros that are to be used for implementing of a first set of functions within the PHC;
optimizing the first group of FCB macros in accordance with the first performance parameters; and,
programming the first group of optimized macros into the PHC in order to form a programmed PHC that operates using the first performance parameters.

21. A method according to claim 20, wherein the first performance parameters relate to power consumption.

22. A method of programming a programmable hardware circuit (PHC) to provide a programmed PHC, the programmed PHC for providing circuit functionality using functional circuit blocks (FCB)s comprising:
providing first performance parameters;
providing second performance parameters;
determining a first group of FCB macros that are to be used for implementing of a first set of functions within the PHC;
determining a second group of FCB macros that are to be used for implementing of a second set of functions within the PHC;
optimizing the first group of FCB macros in accordance with the first performance parameters;
optimizing the second group of FCB macros in accordance with the second performance parameters;
programming the first group and the second group of optimized macros into the PHC in order to form a programmed PHC that operates using one of the first performance parameter and the second performance parameters; and,
providing an input port for receiving a mode of operation signal to select whether the programmed PHC is to operate using one of the first performance parameter and the second performance parameters.

23. A method according to claim 22, wherein the first performance parameters are different than the second performance parameters.

24. A method according to claim 22, wherein at least one of the first performance parameter and the second performance parameters relate to power consumption.

25. A method according to claim 22, comprising of providing a profile processor, the profile processor for balancing performance of the first performance parameters with respect to the second performance parameters.
